(19) United States
(12) Patent Application Publication
(10) Pub. No.: US 2026/0195617 A1
(43) Pub. Date: Jul. 9, 2026

(54) APPARATUS OF ARTIFICIAL INTELLIGENCE AGENT AND COMPUTER-IMPLEMENTED METHOD

(71) Applicant: ELECTRONICS AND TELECOMMUNICATIONS RESEARCH INSTITUTE, Daejeon (KR)

(72) Inventors: Dongsoo Lee, Daejeon (KR); Hayoung Lee, Daejeon (KR); Nack Woo KIM, Daejeon (KR); Won-Young Kim, Daejeon (KR); Munyoung Lee, Daejeon (KR)

(21) Appl. No.: 19/439,223

(22) Filed: Jan. 2, 2026

(30) Foreign Application Priority Data
Jan. 3, 2025 (KR) 10-2025-0001189
Dec. 30, 2025 (KR) 10-2025-0215217

(51) Int. Cl. G06N 5/04; G06F 18/22

(52) U.S. Cl. CPC G06N 5/04; G06F 18/22

(57) ABSTRACT

Provided are an artificial intelligence (AI) agent device and a computer-implemented method. The AI agent device includes: an arbiter engine that decomposes input information into pieces of single atomic information composed of keywords and connection status; a query augmentation engine configured to perform a retrieval in a knowledge base on the basis of the single atomic information input from the arbiter engine, combine information of the single atomic information and information retrieved from the knowledge base, and transmit a query to an AI system; and a retrieval and analysis engine configured to receive results of the AI system decomposed into pieces of single atomic information from the arbiter engine, perform a retrieval in the knowledge base on the basis of keywords and connection status, and determine whether each of the decomposed results of the AI system is deliverable to a user.

### CROSS-REFERENCE TO RELATED APPLICATIONS

This application claims priority to and the benefit of Korean Patent Application No. 10-2025-0001189, filed on Jan. 3, 2025, and Korean Patent Application No. 10-2025-0215217, filed on Dec. 30, 2025, the disclosure of which is incorporated herein by reference in its entirety.

### BACKGROUND

### 1. Field of the Invention

The present invention relates to an artificial intelligence (AI) agent device and a computer-implemented method, and more particularly, to an AI agent for a user who uses AI.

### 2. Discussion of Related Art

Generative artificial intelligence (AI) technology developed on the basis of deep neural networks is expected to be most widely used in the gaming sector (AlphaGo for go, AlphaStar for StarCraft, etc.), the image and video generation sector (films, advertisements, webtoons, etc.), and the conversational service sector (chatbots, AI speakers, etc.).

AI technology is advancing rapidly, and its direction is toward achieving artificial general intelligence (AGI) for processing a variety of real-world tasks with human-like intelligence. The advancement of AI may significantly increase productivity by performing tasks faster and more accurately than humans and enables vast amounts of information to be processed, based on which knowledge may be effectively conveyed. Accordingly, it is expected to provide the society with various benefits such as enabling anyone to easily utilize knowledge and creating new jobs.

However, generative AI may sometimes produce unreliable results. For example, hallucinations where AI responds to human queries with untrue information as if it were factual may occur, or AI may generate answers that contradict universal human values or ethical standards, or generate and disseminate results prohibited within human society.

This occurs when AI models generate undesirable results through inference without explicit training. At the current technological level, such unreliable results are produced with a statistically significant probability.

Also, the black-box nature of large language models (LLMs) where their decision-making processes remain opaque, makes result interpretation difficult, limiting users'ability to understand or control the decision-making process of the LLMs. These problems may put users in serious risk, particularly when AI systems make critical decisions or operate in automated ways.

Therefore, to ensure that AI produces safe and reliable results, the related art is being researched to train (learn) AI to make ethical choices or induce behaviour in ways consistent with human values, thereby aligning AI with human values and common ethical sensibilities.

However, general users are more likely to utilize AI that has been fine-tuned or further trained on the basis of commercialized models, and have limitations in developing and training AI systems.

Consequently, in order for companies and individuals utilizing AI to efficiently and effectively use AI, it is necessary to make AI reliable with limited computing resources within the utilization range of AI.

### SUMMARY OF THE INVENTION

The present invention is directed to providing an artificial intelligence (AI) agent device and a computer-implemented method for reducing the risk of hallucinations and inappropriate responses by analyzing whether responses generated by an AI system align with factual propositions and providing only deliverable responses to a user even in a user environment not involved in development or training of the AI system.

According to an aspect of the present invention, there is provided an AI agent device including: an arbiter engine configured to decompose input information into pieces of single atomic information composed of keywords and connection status; a query augmentation engine configured to perform a retrieval in a knowledge base on the basis of the single atomic information input from the arbiter engine, combine information of the single atomic information and information retrieved from the knowledge base, and transmit a query to an AI system; and a retrieval and analysis engine configured to receive results of the AI system decomposed into pieces of single atomic information from the arbiter engine, perform a retrieval in the knowledge base on the basis of keywords and connection status, and determine whether each of the decomposed results of the AI system is deliverable to a user. The arbiter engine repeatedly requests the query augmentation engine to transmit the query to the AI system on the basis of a result output from the retrieval and analysis engine until a result deliverable to the user is acquired.

The arbiter engine may decompose a query input by the user and the results output from the AI system into sentence-specific atomic sentences.

The arbiter engine may extract keywords and relationships between the keywords from each of atomic sentences and generate single atomic information in a keyword-connection status-keyword form.

To reserve contextual correlations between the pieces of single atomic information, the arbiter engine may generate connected atomic information by connecting a plurality of pieces of single atomic information on the basis of entities included in common in the pieces of single atomic information.

The knowledge base may store single atomic information configured in a keyword-connection status-keyword form and connected atomic information acquired by connecting a plurality of pieces of single atomic information on the basis of entities included in common in the plurality of pieces of single atomic information.

The query augmentation engine may determine additional information to be included in the query by calculating similarities with the information stored in the knowledge base on the basis of the keywords and connection status of the plurality of pieces of input single atomic information, establish a knowledge connection path by connecting the plurality of pieces of input single atomic information and the additional information, and then generate a prompt to be provided to the AI system on the basis of the knowledge connection path.

The retrieval and analysis engine may determine whether each of the decomposed results of the AI system is deliverable to the user by calculating similarities with the information stored in the knowledge base on the basis of the keywords and connection status of the plurality of pieces of input single atomic information, wherein the retrieval and analysis engine may classify each decomposed result as appropriate information deliverable to the user when the similarity is greater than or equal to a threshold, and classify each decomposed result as inappropriate information undeliverable to the user when the similarity is smaller than the threshold.

The query augmentation engine may generate a modified prompt including a constraint that instructs the AI system to exclude content corresponding to the inappropriate information when generating a follow-up response, and may transmit the modified prompt to the AI system.

The arbiter engine may store a query input by the user and a final response to the query as a pair and, when the input query is determined to be identical to a previously responded query stored in a memory and there is no change to content of the knowledge base, may output a response stored in the memory without operating the query augmentation engine.

According to another aspect of the present invention, there is provided a computer-implemented method performed by a computing device, the computer-implemented method including: receiving a query to be input to an AI system from a user; decomposing the input query information into pieces of single atomic information composed of keywords and connection status; performing a retrieval in a knowledge base on the basis of the single atomic information; combining information of the single atomic information and information retrieved from the knowledge base and transmitting a query to the AI system; receiving a result output from the AI system; determining whether the result is deliverable to the user by comparing the result of the AI system with information stored in the knowledge base; and outputting the result of the AI system when the result is deliverable to the user.

The receiving of the query may include: determining whether there is a previously stored response corresponding to the query in the memory; and when there is the previously stored response and it has been less than a certain period after generation of the previously stored response or there has been no change to content of the knowledge base during the certain period, outputting the previously stored response to the user.

The decomposing of the input query information into the pieces of single atomic information may include decomposing the input information into a plurality of atomic sentences in accordance with a grammatical structure and extracting keywords and relationships between the keywords from each of the atomic sentences and generating single atomic information in a keyword-connection status-keyword form.

The generating of the single atomic information may include generating connected atomic information by connecting a plurality of pieces of single atomic information on the basis of entities included in common in the pieces of single atomic information.

The knowledge base may store single atomic information configured in a keyword-connection status-keyword form and connected atomic information acquired by connecting a plurality of pieces of single atomic information on the basis of entities included in common in the plurality of pieces of single atomic information.

The performing of the retrieval may include determining additional information to be included in the query by calculating similarities with the information stored in the knowledge base on the basis of the keywords and connection status of the plurality of pieces of single atomic information.

The transmitting of the query may include establishing a knowledge connection path by connecting the plurality of pieces of single atomic information and the additional information, and then generating a prompt to be provided to the AI system on the basis of the knowledge connection path.

The determining of whether the result is deliverable to the user may include: decomposing the result into a plurality of pieces of single atomic information; calculating a similarity of each piece of the single atomic information with the information stored in the knowledge base; and determining whether each piece of the decomposed single atomic information is deliverable to the user on the basis of the similarity.

The determining of whether each piece of the decomposed single atomic information is deliverable to the user may include classifying the piece of the single atomic information as appropriate information deliverable to the user when the similarity is greater than or equal to a threshold, and classifying the piece of the single atomic information as inappropriate information undeliverable to the user when the similarity is smaller than the threshold.

The computer-implemented method may further include, when there is the inappropriate information, generating a modified prompt instructing the AI system to exclude content corresponding to the inappropriate information, transmitting the modified prompt to the AI system, and repeating the generating of the modified prompt and the transmitting of the modified prompt until there is no inappropriate response-unit information as a response of the AI system for the modified prompt.

According to another aspect of the present invention, there is provided an AI agent device including: at least one processor; and a memory configured to store instructions. When executed by the at least one processor, the instructions cause the at least one processor to perform: receiving a query to be input to an AI system from a user; decomposing the received query information into pieces of single atomic information composed of keywords and connection status; performing a retrieval in a knowledge base on the basis of the single atomic information; combining information of the single atomic information and information retrieved from the knowledge base and transmitting a query to the AI system; receiving a result output from the AI system; determining whether the result of the AI system is deliverable to the user by comparing the result with information stored in the knowledge base; and outputting the result of the AI system when the result of the AI system is deliverable to the user.

### BRIEF DESCRIPTION OF THE DRAWINGS

The above and other objects, features, and advantages of the present invention will become more apparent to those of ordinary skill in the art by describing exemplary embodiments thereof in detail with reference to the accompanying drawings, in which:

FIG. 1 is a block diagram of an artificial intelligence (AI) agent device according to some embodiments of the present invention;

FIGS. 2 and 3 are diagrams illustrating atomic information of an AI agent device according to some embodiments of the present invention;

FIG. 4 is a diagram illustrating a computing device on which an AI agent device may be implemented according to some embodiments of the present invention; and

FIG. 5 is a flowchart illustrating a computer-implemented method according to some embodiments of the present invention.

### DETAILED DESCRIPTION OF EXEMPLARY EMBODIMENTS

Hereinafter, an artificial intelligence (AI) agent device and a computer-implemented method according to the present invention will be described with reference to the accompanying drawings. In this process, the thicknesses of lines, the sizes of components, etc., shown in the drawings may be exaggerated for the purpose of clarity and convenience of description. Moreover, terms used herein are defined in consideration of functions in the present invention, and the terms may vary depending on the intention of a user or operator or precedents thereof. Therefore, these terms are to be defined on the basis of the overall content of the specification.

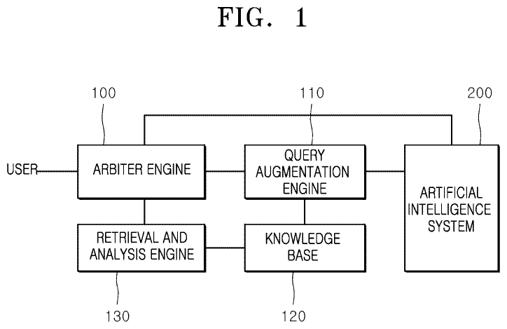

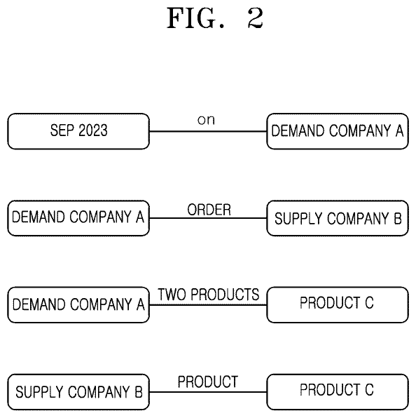

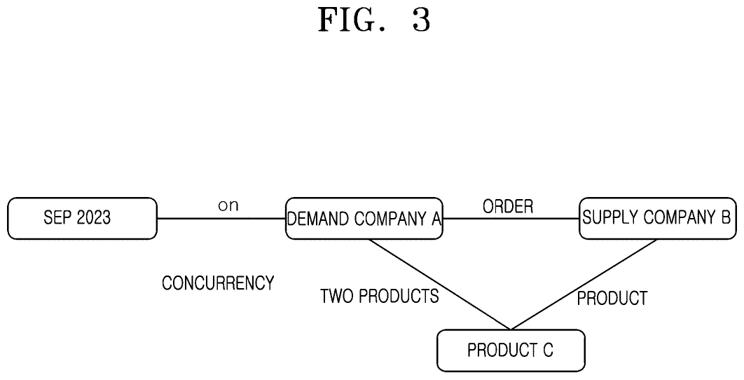

FIG. 1 is a block diagram of an AI agent device according to some embodiments of the present invention, and FIGS. 2 and 3 are diagrams illustrating atomic information of an AI agent device according to some embodiments of the present invention.

The AI agent device of FIG. 1 according to some embodiments of the present invention includes an arbiter engine 100, a query augmentation engine 110, a knowledge base 120, and a retrieval and analysis engine 130.

Meanwhile, an AI system 200 may be in various forms such as a large language model (LLM)-based service, a generative AI application programming interface (API), an internal/external company AI response server, etc., and the AI agent device may transmit a query to the AI system 200 via a network and receive a response. Also, the AI agent device may function as a safety control layer that performs verification on external outputs, rather than as a structure that internally guarantees the correctness of the AI system 200.

The arbiter engine 100 may decompose input information (a user query Q or a response of the AI system 200) into a plurality of atomic sentences in accordance with a grammatical structure. Here, the atomic sentences do not simply represent sentence separation but are acquired by decomposing a plurality of relationships in sentences into smallest meaningful units that may be handled independently, in consideration of dependency constructions and semantic roles.

The arbiter engine 100 may extract a keyword and connection status from each atomic sentence and generate single atomic information in a keyword-connection status-keyword form. Single atomic information may be expressed as a triplet, encompassing various expressive forms that may describe semantic relationships such as subject-relator-predicate, subject-predicate-object, or the like. In other words, single atomic information may be understood as a smallest unit acquired by converting natural language text into relationship-centered structured information.

Also, the arbiter engine 100 may generate connected atomic information by connecting a plurality of pieces of single atomic information on the basis of entities included in common in the pieces of single atomic information to preserve contextual correlations between the pieces of single atomic information.

Forms of single atomic information and connected atomic information will be described in further detail below with the knowledge base 120.

The query augmentation engine 110 may perform a retrieval in the knowledge base 120 on the basis of single atomic information (query-unit information) Σq input from the arbiter engine 100 and generate a prompt (query) to be transmitted to the AI system 200 by combining retrieved information with the query-unit information.

The query augmentation engine 110 may calculate similarities with information stored in the knowledge base 120 on the basis of keywords and connection status of the input single atomic information and determine additional information to be included in a query.

For example, the query augmentation engine 110 may vectorize single atomic information stored in the knowledge base 120 and the query-unit information Σq and perform a nearest neighbor search in a vector space to select a plurality of pieces of knowledge with high similarities as a core knowledge candidate group. Subsequently, the query augmentation engine 110 may calculate a correlation score (or similarity score) for each candidate and determine only core knowledge with a correlation score higher than a preset threshold as additional information Σk. Here, the single atomic information (query-unit information) extracted from the input query and the core knowledge candidate group selected from the knowledge base 120 may be combined into one input sequence to calculate connection scores. Also, when the scores are lower than the threshold, additional information may not be determined.

As another embodiment, the query augmentation engine 110 may search for an entity matching the query-unit information among entities (keywords) stored in the knowledge base 120 in a normalized manner and select a relationship suited to the connection status of the query among relationships of the entity, thereby determining core knowledge (additional information). In other words, the present invention is not limited to an embedding-based search and may encompass a search method employing keyword matching and a graph-based search.

The query augmentation engine 110 may establish a knowledge connection path by connecting the input single atomic information (query-unit information) and the additional information and then generate a prompt to be provided to the AI system 200 on the basis of the knowledge connection path.

Specifically, when the additional information Σk is determined, the query augmentation engine 110 may establish a knowledge connection path by connecting the input single atomic information Σq and the additional information Σk. The knowledge connection path is a path in which pieces of atomic information are consecutively connected in the knowledge base 120. For example, when (Seoul, location, Korea) and (Korea, location, Asia) are connected, a path of (Seoul [symbol] Korean [symbol] Asia) may be established. Such a knowledge connection path expresses indirect or complex relationships between keywords and may induce the AI system 200 to generate an evidence-based response during prompt design. The query augmentation engine 110 may generate a prompt P(Σq+Σk) to be provided to the AI system 200 on the basis of the knowledge connection path. The prompt may include, for example, the user's original question, a core atomic sentence extracted therefrom, fact units (additional information) or a knowledge connection path retrieved from the knowledge base 120, and response writing guidelines. Here, the response writing guidelines may be diversified such as processing responses as unknown/unanswerable when evidence is insufficient, maintaining a consistent structure for responses, etc., and may be meticulously designed in accordance with purpose. In addition, a response guideline for excluding transmitted inappropriate information may be included.

This prompt augmentation may lower the possibility that the AI system 200 generates incomplete or incorrect information.

In addition, even when there is no additional information, the query augmentation engine 110 may generate a prompt on the basis of query-unit information Σq, and the prompt may include a response writing guideline to prevent hallucinations.

The knowledge base 120 stores single atomic information configured in a keyword-connection status-keyword form and connected atomic information acquired by connecting a plurality of pieces of single atomic information on the basis of entities included in common in the pieces of single atomic information.

The knowledge base 120 functions as a storage that serves as a basis for the AI agent device to perform output verification, and all knowledge information included in the knowledge base 120 may be considered factual propositions.

Relationship information (connection status) between keywords stored in the knowledge base 120 may include semantic relationship information for proving factual propositions between keywords, and single atomic information may be connected to a main keyword or sub-keyword of other single atomic information through its main keyword or sub-keyword. Also, two connected keywords and relationship information thereof may be stored as single atomic information. In this way, the knowledge base 120 stores not a mere collection of text but relationship-centered structured information units, enabling verification in which relational consistency is considered during a retrieval and analysis process.

The knowledge base 120 may be implemented as a relational database (RDB) or non-relational database (DB) and may be implemented in a JavaScript Object Notation (JSON)-based storage structure or as a vector database (including embedding indexes). Also, these storage methods may be mixed. For example, original/normalized forms of single atomic information may be stored in a document-type DB, while embedding vectors may be stored in a vector DB, and graph indexes for searching relationships may be separately maintained.

The knowledge base 120 may also include metadata such as creation time, update time, version information, source information, reliability rating, etc., for each knowledge unit to determine update, and the system may use this metadata to determine whether the content of the knowledge base 120 have changed. However, this use of metadata is optional and does not limit the scope of the present invention.

In the present invention, a keyword is a core word or entity that represents a meaning within a sentence, and may include a person, an organization, a product, a place, time, a quantity/attribute, and the like. Also, connection status is information that expresses relationships between keywords, for example, verb relationships (order, inclusion, location, etc.), attribute relationships (quantity, date, state, etc.) or logical relationships (concurrency, causality, etc.).

For example, from the content “demand company A ordered two units of product C, the next-generation model from supply company B,” single atomic information such as (September 2023, on, demand company A), (demand company A, order, supply company B), (demand company A, 2 units, product C), (supply company B, product, product C), etc., may be generated as shown in FIG. 2. and the single atomic information may be connected through common keywords (e.g., demand company A and product C) and selectively given connection information such as concurrency, thereby expressed as connected atomic information constituting one event as shown in FIG. 3.

Information stored in the knowledge base 120 may be previously compiled and organized as a DB by inputting and collecting deliverable information or factual propositions by users.

The retrieval and analysis engine 130 may receive results of the AI system 200 decomposed into single atomic information (i.e., response-unit information Σr) from the arbiter engine 100 and performs a retrieval in the knowledge base 120 on the basis of a keyword and connection status to determine whether each decomposed result of the AI system 200 is deliverable to the user.

Also, the retrieval and analysis engine 130 may calculate similarities with information stored in the knowledge base 120 on the basis of the keywords and connection status of the input single atomic information and determine whether each decomposed result of the AI system 200 is deliverable to the user. Here, the retrieval and analysis engine 130 may classify each decomposed result as appropriate information Σrₛ deliverable to the user when the similarity is greater than or equal to a threshold, and classify each decomposed result as inappropriate information Σrₙₒₜ undeliverable to the user when the similarity is smaller than the threshold.

Specifically, the retrieval and analysis engine 130 may retrieve an entity (keyword) and relationship (connection status) information associated with each piece of response-unit information Σr from the knowledge base 120 and compare a retrieval result Σr_{KB} with the response-unit information Σr to calculate a similarity. Here, similarity calculation may be performed using a variety of metrics such as a cosine similarity, an inner product, a distance-based score, a rule-based matching score, etc., and the present invention is not limited to any specific similarity metric. Here, the threshold may be set in accordance with system policies or user policies. In high-risk domains (e.g., legal, medical, and safety domains), a stricter threshold may be applied for conservative judgments.

In addition, the retrieval and analysis engine 130 may not only determine whether single atomic information exists in the knowledge base 120 but may also determine whether the single atomic information is a hallucination more precisely by additionally classifying whether relationships (connection status) of the single atomic information are logically consistent or contradictory. For example, when relationship labels are contradictory or inconsistent even with the same keyword existing in the knowledge base 120, the single atomic information may be determined to be inappropriate. Due to this configuration, it is possible to reduce misjudgment based on simple keyword similarity and enhance reliability evaluation based on factual propositions.

When the retrieval and analysis engine 130 classifies the response-unit information as appropriate information Σr and inappropriate information Σrₙₒₜ and there is no inappropriate information Σrₙₒₜ, the AI agent device may determine a corresponding response as a final response R_{f} and output the final response R_{f} to the user.

Information output to the user may be transmitted through the arbiter

engine 100. Also, to improve response efficiency of the same query thereafter, the arbiter engine 100 may store response information {Q, Rᵢ} in a memory.

On the other hand, when there is inappropriate information Σrₙₒₜ, the AI agent device may modify a prompt to exclude content corresponding to the inappropriate information from a follow-up response and transmit the modified prompt to the AI system 200.

For example, the query augmentation engine 110 may generate a modified prompt including a constraint that instructs the AI system 200 to exclude content corresponding to inappropriate information and transmit the modified prompt to the AI system 200. As an example, the modified prompt may include constraint text such as “exclude a specific assertion (corresponding to single atomic information) among previous responses because it is not confirmed in the knowledge base 120.”

Also, the modified prompt does not only exclude inappropriate information Σrₙₒₜ but also provide fact units (e.g., Σr_{KB}) of the knowledge base 120 corresponding to keywords and connection status associated with the inappropriate information and thereby may induce the AI system 200 to correct the corresponding part to align with the facts. However, this correction induction method is optional, and a prompt configuration may vary depending on service policies, user policies, or domain requirements.

The query augmentation engine 110 may repeatedly request transmission of a query to the AI system 200 on the basis of a result of the retrieval and analysis engine 130 until a result deliverable to the user is acquired. In other words, when the AI system 200 generates a re-response to the modified prompt and transmits the re-response, the AI agent device may repeat a process of decomposing the re-response (generating response-unit information) again and comparing the response-unit information with the knowledge base 120 to determine whether there is inappropriate information. This repetition may be performed until there is not inappropriate response-unit information any more.

Meanwhile, repetition control is not premised on infinite repetition and may be configured to stop repetition and output a specific decision on the basis of response decision criteria determined by the user. For example, depending on whether core knowledge associated with query-unit information exists in the knowledge base 120, a determined response such as “unable to answer the question” may be output, or the repetition may be stopped on the basis of the number of repetition requests (e.g., maximum N times) or an elapsed time (e.g., maximum T seconds). These response decision criteria may be defined variously in consideration of system stability and user experience.

Meanwhile, the arbiter engine 100 may output a response stored in the memory to the user without operating the query augmentation engine 110 when the input query is determined to be identical to a previously responded query stored in the memory and either it has been less than a certain period after generation of the previously stored response or there has been no change to content of the knowledge base 120 during the certain period.

With this configuration, it is possible to improve system resource efficiency by reducing repetitive computations on the same query and calls to the external AI system 200.

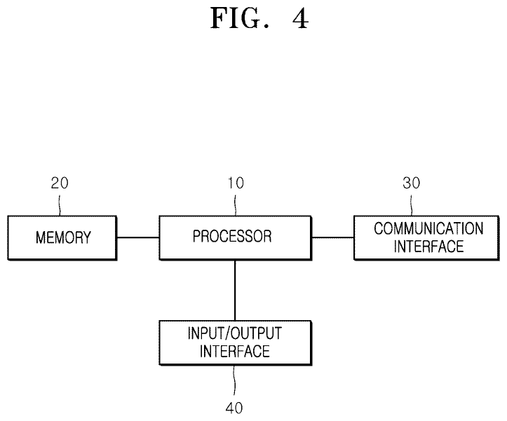

FIG. 4 is a diagram illustrating a computing device on which an AI agent device may be implemented according to some embodiments of the present invention.

Referring to FIG. 4, an embodiment of the present invention may be implemented on a computing device including at least one processor 10 and a memory 20 storing instructions. The processor 10 may be configured to perform functions of the arbiter engine 100, the query augmentation engine 110, and the retrieval and analysis engine 130 by executing the instructions stored in the memory 20. Operations of the AI agent device may constitute a computer-implemented method.

For example, these instructions may cause the processor 10 to perform an operation of receiving a query to be input to an AI system from a user, an operation of decomposing the input query information into pieces of single atomic information composed of keywords and connection status, an operation of performing a retrieval in a knowledge base on the basis of the single atomic information, an operation of combining information of the single atomic information and information retrieved from the knowledge base and transmitting a query to the AI system, an operation of receiving a result output from the AI system, an operation of determining whether the result is deliverable to the user by comparing the result of the AI system with information stored in the knowledge base, and an operation of outputting the result of the AI system when the result is deliverable to the user.

Also, a communication interface 30 may be used to perform network communication with the AI system 200 or the knowledge base 120 through a wired and wireless communication module, and an input/output interface 40 including a monitor, a mouse, a keyboard, etc., may be used to support user input and result output (e.g., screen display, voice output, log storage, etc.).

The processor 10 may include an electronic control unit (ECU), a central processing unit (CPU), a graphics processing unit (GPU), a digital signal processor (DSP), a memory, or a similar computational device.

The memory 20 may include at least one of a flash memory type, a hard disk type, a multimedia card micro type, a card-type memory (e.g., a secure digital (SD) memory, an extreme digital (XD) memory, etc.), a random access memory (RAM), a static random access memory (SRAM), a read-only memory (ROM), a electrically erasable programmable read-only memory (EEPROM), a programmable read-only memory (PROM), a mask ROM, a flash ROM, a hard disk drive (HDD), and a solid state drive (SSD).

In embodiments of the present invention, the engines 100, 110, and 130 may be implemented in one physical device or may be implemented in different physical devices in a distributed manner. For example, the arbiter engine 100 may be implemented in a user terminal, and the query augmentation engine 110, the retrieval and analysis engine 130, and the knowledge base 120 may be implemented in a cloud server and interoperate with the arbiter engine 100 via a network. Also, the single query augmentation engine 110 may request a task from one or more AI systems 200 or cross-validate responses from a plurality of AI systems 200.

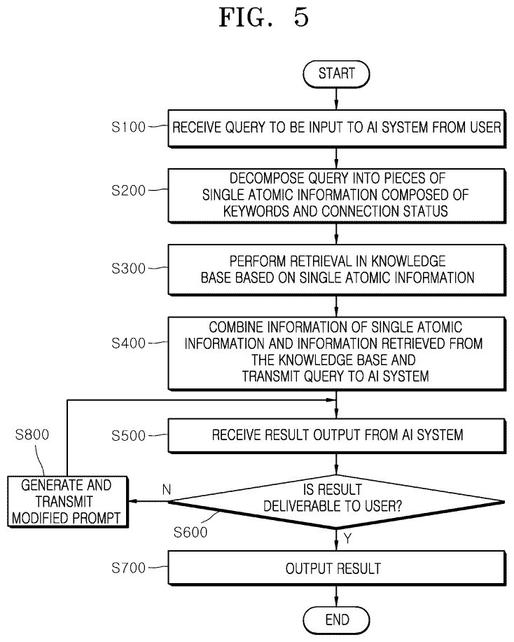

FIG. 5 is a flowchart illustrating a computer-implemented method according to some embodiments of the present invention.

First, the AI agent device receive a query to be input to the AI system 200 from a user (S100). Then, the AI agent device decomposes the input query information into pieces of single atomic information composed of keywords and connection status (S200).

Subsequently, the AI agent device performs a retrieval in the knowledge base 120 on the basis of the single atomic information (S300). Subsequently, the AI agent device combines the information of the single atomic information with information retrieved from the knowledge base 120 and transmits a query to the AI system 200 (S400).

The AI agent device receives a result output from the AI system 200 (S500). Subsequently, the AI agent device compares the result of the AI system 200 with information stored in the knowledge base 120 to determine whether the result is deliverable to a user (S600).

When the result is deliverable to the user, the AI agent device outputs the result of the AI system 200 (S700). On the other hand, when the result is undeliverable to the user, the AI agent device generates and transmits a modified prompt such that inappropriate information is not included (S800).

After operation S800, the above process may return to operations S500 and S600 for repetition and may be repeated until there is not inappropriate response-unit information any more.

Before or in combination with operation S100, another embodiment of the present invention may include a cache-based process of determining whether there is a previously stored response ({Q_{M}, R_{M}} stored in the memory 20) and outputting the previously stored response to the user without performing some of operations S200 to S800 when no update is necessary.

As described above, the AI agent device and the computer-implemented method according to embodiments of the present invention do not train an AI system or change internal parameters but verify an output of the AI system on the basis of factual propositions (or knowledge considered as facts) stored in a knowledge base within a user's environment and repeatedly modify a prompt as necessary to prevent inappropriate outputs (including hallucinations) from being transmitted to the user. In other words, the AI agent device is designed for a user to control safety using limited computing resources even when the user is not associated with AI system development.

In this way, the AI agent device and the computer-implemented method according to embodiments of the present invention determine whether AI system responses are appropriate or inappropriate on the basis of factual propositions in a knowledge base and repeatedly make a query while modifying a prompt to exclude an inappropriate part, thereby preventing a hallucination or inappropriate response to be delivered to a user. In addition, safe and reliable control is possible within a user environment without retraining an AI system or using large-scale computing resources.

An AI agent device and a computer-implemented method according to the present invention determine whether an AI system response is appropriate or inappropriate on the basis of factual propositions in a knowledge base and repeatedly make a query while modifying a prompt to exclude an inappropriate part, thereby preventing a hallucination or inappropriate response to be delivered to a user.

In addition, an AI agent device and a computer-implemented method according to the present invention enable safe and reliable control in a user environment without retraining an AI system or using large-scale computing resources.

Although the present invention has been described above with reference to embodiments shown in the drawings, the embodiments are merely illustrative, and it would be appreciated by those skilled in the art that various modifications and other embodiments equivalent thereto can be made therefrom. Therefore, the technical scope of the present invention should be determined from the following claims.

What is claimed is:

1. An artificial intelligence (AI) agent device comprising:
an arbiter engine configured to decompose input information into pieces of single atomic information composed of keywords and connection status;
a query augmentation engine configured to perform a retrieval in a knowledge base on the basis of the single atomic information input from the arbiter engine, combine information of the single atomic information and information retrieved from the knowledge base, and transmit a query to an AI system; and
a retrieval and analysis engine configured to receive results of the AI system decomposed into pieces of single atomic information from the arbiter engine, perform a retrieval in the knowledge base on the basis of keywords and connection status, and determine whether each of the decomposed results of the AI system is deliverable to a user,
wherein the arbiter engine repeatedly requests the query augmentation engine to transmit the query to the AI system on the basis of a result output from the retrieval and analysis engine until a result deliverable to the user is acquired.

2. The AI agent device of claim 1, wherein the arbiter engine decomposes a query input by the user and the results output from the AI system into sentence-specific atomic sentences.

3. The AI agent device of claim 2, wherein the arbiter engine extracts keywords and relationships between the keywords from each of atomic sentences and generates single atomic information in a keyword-connection status-keyword form.

4. The AI agent device of claim 3, wherein, to reserve contextual correlations between the pieces of single atomic information, the arbiter engine generates connected atomic information by connecting a plurality of pieces of single atomic information on the basis of entities included in common in the pieces of single atomic information.

5. The AI agent device of claim 1, wherein the knowledge base stores single atomic information configured in a keyword-connection status-keyword form and connected atomic information acquired by connecting a plurality of pieces of single atomic information on the basis of entities included in common in the plurality of pieces of single atomic information.

6. The AI agent device of claim 5, wherein the query augmentation engine determines additional information to be included in the query by calculating similarities with the information stored in the knowledge base on the basis of the keywords and connection status of the plurality of pieces of input single atomic information, establishes a knowledge connection path by connecting the plurality of pieces of input single atomic information and the additional information, and then generates a prompt to be provided to the AI system on the basis of the knowledge connection path.

7. The AI agent device of claim 5, wherein the retrieval and analysis engine determines whether each of the decomposed results of the AI system is deliverable to the user by calculating similarities with the information stored in the knowledge base on the basis of the keywords and connection status of the plurality of pieces of input single atomic information,
wherein the retrieval and analysis engine classifies each decomposed result as appropriate information deliverable to the user when the similarity is greater than or equal to a threshold, and classifies each decomposed result as inappropriate information undeliverable to the user when the similarity is smaller than the threshold.

8. The AI agent device of claim 7, wherein the query augmentation engine generates a modified prompt including a constraint that instructs the AI system to exclude content corresponding to the inappropriate information when generating a follow-up response, and transmits the modified prompt to the AI system.

9. The AI agent device of claim 1, wherein the arbiter engine stores a query input by the user and a final response to the query as a pair and, when the input query is determined to be identical to a previously responded query stored in a memory and there is no change to content of the knowledge base, outputs a response stored in the memory without operating the query augmentation engine.

10. A computer-implemented method performed by a computing device, comprising:
receiving a query to be input to an artificial intelligence (AI) system from a user;
decomposing the input query information into pieces of single atomic information composed of keywords and connection status;
performing a retrieval in a knowledge base on the basis of the single atomic information;
combining information of the single atomic information and information retrieved from the knowledge base and transmitting a query to the AI system;
receiving a result output from the AI system;
determining whether the result is deliverable to the user by comparing the result of the AI system with information stored in the knowledge base; and
outputting the result of the AI system when the result is deliverable to the user.

11. The computer-implemented method of claim 10, wherein the receiving of the query comprises:
determining whether there is a previously stored response corresponding to the query in the memory; and
when there is the previously stored response and it has been less than a certain period after generation of the previously stored response or there has been no change to content of the knowledge base during the certain period, outputting the previously stored response to the user.

12. The computer-implemented method of claim 10, wherein the decomposing of the input query information into the pieces of single atomic information comprises decomposing the input information into a plurality of atomic sentences in accordance with a grammatical structure and extracting keywords and relationships between the keywords from each of the atomic sentences and generating single atomic information in a keyword-connection status-keyword form.

13. The computer-implemented method of claim 12, wherein the generating of the single atomic information comprises generating connected atomic information by connecting a plurality of pieces of single atomic information on the basis of entities included in common in the pieces of single atomic information.

14. The computer-implemented method of claim 10, wherein the knowledge base stores single atomic information configured in a keyword-connection status-keyword form and connected atomic information acquired by connecting a plurality of pieces of single atomic information on the basis of entities included in common in the plurality of pieces of single atomic information.

15. The computer-implemented method of claim 14, wherein the performing of the retrieval comprises determining additional information to be included in the query by calculating similarities with the information stored in the knowledge base on the basis of the keywords and connection status of the plurality of pieces of single atomic information.

16. The computer-implemented method of claim 15, wherein the transmitting of the query comprises establishing a knowledge connection path by connecting the plurality of pieces of single atomic information and the additional information, and then generating a prompt to be provided to the AI system on the basis of the knowledge connection path.

17. The computer-implemented method of claim 14, wherein the determining of whether the result is deliverable to the user comprises:
decomposing the result into a plurality of pieces of single atomic information;
calculating a similarity of each piece of the single atomic information with the information stored in the knowledge base; and
determining whether each piece of the decomposed single atomic information is deliverable to the user on the basis of the similarity.

18. The computer-implemented method of claim 17, wherein the determining of whether each piece of the decomposed single atomic information is deliverable to the user comprises classifying the piece of the single atomic information as appropriate information deliverable to the user when the similarity is greater than or equal to a threshold, and classifying the piece of the single atomic information as inappropriate information undeliverable to the user when the similarity is smaller than the threshold.

19. The computer-implemented method of claim 18, further comprising, when there is the inappropriate information, generating a modified prompt instructing the AI system to exclude content corresponding to the inappropriate information, transmitting the modified prompt to the AI system, and repeating the generating of the modified prompt and the transmitting of the modified prompt until there is no inappropriate response-unit information as a response of the AI system for the modified prompt.

20. An artificial intelligence (AI) agent device comprising:
at least one processor; and
a memory configured to store instructions,
wherein, when executed by the at least one processor, the instructions cause the at least one processor to perform:
receiving a query to be input to an AI system from a user;
decomposing the received query information into pieces of single atomic information composed of keywords and connection status;
performing a retrieval in a knowledge base on the basis of the single atomic information;
combining information of the single atomic information and information retrieved from the knowledge base and transmitting a query to the AI system;
receiving a result output from the AI system;
determining whether the result of the AI system is deliverable to the user by comparing the result with information stored in the knowledge base; and
outputting the result of the AI system when the result of the AI system is deliverable to the user.
